(19) United States
(12) Patent Application Publication
(10) Pub. No.: US 2025/0257863 A1
(43) Pub. Date: Aug. 14, 2025

(54) LIGHT SHEET BUMPERS AND INSTALLATION KIT WITH SUCH BUMPERS

(71) Applicant: BROOKSCO, LLC, Wheatridge, CO (US)

(72) Inventors: YULIN XU, Shenzhen (CN); ZHISHENG ZHOU, Shenzhen (CN); DAVID BROOKS, Wheatridge, CO (US)

(21) Appl. No.: 19/028,564

(22) Filed: Jan. 17, 2025

(30) Foreign Application Priority Data
Feb. 8, 2024 (CN) 202410178095.X

(51) Int. Cl. F21V 15/01; F21V 17/00; F21V 17/06; F21Y 105/16; F21Y 115/10

(52) U.S. Cl. CPC F21V 15/01; F21V 17/005; F21V 17/06; F21Y 2105/16; F21Y 2115/10

(57) ABSTRACT

Bumpers for maintaining a gap between a light sheet and a translucent material in backlighting applications, as well as installation kits comprising light sheets and such bumpers. In some embodiments, the bumper comprises a base part having a central body, one or more bumper members, and at least one arm section which extends radially outward from the central body and connects to a respective bumper member opposite the central body. The central body may have an opening for receiving a fastener therethrough, with each bumper further comprising a cap part for covering the opening. Bumper member profiles are also specified with respect to height, radial extension, and convex curvature parameters.

### BACKGROUND

Light sheets are used to illuminate translucent materials, such as glass or stone for example, in various backlighting applications. Such backlighting applications may include floors, walls, ceilings, tables, counters, bars, backsplashes, shelves, signs, displays, artwork, etc. FIG. 1 shows a countertop 10 as one possible example of a backlit material in a backlighting application. It should be appreciated that a backlit material may have opaque sections by design, in addition to translucent sections provided for light diffusion. Such light sheets typically have a plurality of light emitting diodes (LEDs). The light sheet preferably produces a uniform field of illumination in order to avoid observable areas of different brightness on the backlit surface. The light sheet is also preferably flexible for use with non-flat surfaces such as, for example, curved or cornered surfaces.

Bumpers, which may also be referred to as spacers or standoffs, are used to ensure a gap between the light sheet and backlit material. For example, bumpers may be used in horizontal applications to support a backlit material arranged above the light sheet, and thus also accommodate and protect the LEDs and other components with respect to the backlit material. Bumpers with a semispherical or dome shape have been used for this purpose. FIG. 2 shows such a dome-shaped bumper 50 positioned between the countertop 10 and a flexible light sheet 20. The light sheet 20 is mounted on counter substrate 12 including over a corner edge thereof. The bumpers 50 produce a gap 14 between the countertop 10 and light sheet 20. The gap 14 accommodates the LEDs 22 and other light sheet components with respect to the countertop 10. FIG. 3 shows a portion of the light sheet 20 with multiple bumpers 50 before the countertop 10 has been installed thereon. Prior to installation of the countertop 10, the bumpers 50 are adhesively mounted to the light sheet 20. A sufficient number of bumpers 50 are used in view of the bumper weight rating, weight of the countertop 10 and specified load capacity. The bumpers 50 are preferably positioned to evenly support the countertop 10.

However, such bumpers are susceptible to dislodging and rolling out of place during the installation process, which can result in damage to the light sheet and/or subpar final product results. Bumpers have also been known to produce observable spots of uneven brightness, such as dark or shadow spots, relative to the surrounding areas of the illuminated material.

The foregoing examples of the related art and limitations therewith are intended to be illustrative and not exclusive. Other limitations will become apparent to those skilled in the art upon a reading of the specification and a study of the drawings.

### SUMMARY

The following embodiments and aspects thereof are described and depicted in conjunction with systems, tools and methods which are meant to be illustrative, not limiting in scope. In various embodiments, one or more problems have been reduced or eliminated, while other embodiments are directed to other improvements.

Proceeding from this background, the disclosure relates to a bumper for maintaining the gap between a light sheet and a backlit material in backlighting applications, as well as a light sheet installation kit comprising a light sheet and a plurality of such bumpers. One aspect is directed to providing a bumper which avoids, or at least reduces, unintentional displacements of the bumper during installation. Another aspect is directed to providing a bumper which avoids, or at least reduces, the formation of uneven brightness spots along the backlit material.

According to some embodiments, the bumper is provided as a standalone bumper member. Preferably, the bumper comprises a bumper member with a height, which extends from base to tip along an axis of the bumper member, and a maximum radial extension transverse to this axis that is 30-70% of the height of the bumper member. In some embodiments, the maximum radial extension is 40-60% of the height. Preferably, the bumper member is convexly curved through at least a portion of its height with a radius of curvature, and a ratio of the radius of curvature to the height of the bumper member is in the range of 1.3-1.7. In some embodiments, the ratio of the radius of curvature to the height is 1.4-1.6. The portion of the height, through which the bumper member is convexly curved, may comprise at least 95% of the height of the bumper member. In some embodiments, the portion comprises 97-99% of the height of the bumper member. The bumper member may have a truncated cone shape with the convexly curved side surface that transitions into a convex or flat tip. The bottom side of the bumper may be provided with adhesive backing for attaching the bumper to a light sheet.

According to some embodiments, the bumper comprises a base part having a central body, one or more bumper members, and at least one arm section which extends radially outward from the central body and which connects to a side of a respective bumper member of the one or more bumper members opposite the central body. The one or more bumper members may be designed in the manner of a standalone bumper member described above. Preferably, the central body has an opening for receiving a fastener therethrough, and the bumper further comprises a cap part which is mountable to the base part for covering the opening of the central body. The rim of the opening, on the top side of the central body, may have one or more outward projections for elastically mounting the cap part thereover. The bumper member is preferably larger in height than the central body with the cap part thereon. The arm section is preferably smaller in height and/or width than the central body and the bumper member, and extends between lower portions of the central body and the bumper member. The bottom side of the base part may be provided with adhesive backing for attaching the bumper to a light sheet.

Preferably, the base part has more than one bumper member and corresponding arm section. For example, the base part may have two bumper members and two arm sections, with the two arm sections arranged perpendicular to each other or aligned in a transverse axis through the central body. In other embodiments, the base part may have three bumper members and respective three arm sections. Preferably, the base part has four bumper members and four arm sections. For example, the four arm sections may be arranged around the central body equidistant from one another to form a cross shape.

A light sheet installation kit for backlighting a backlit material comprises a plurality of bumpers according to the disclosure, and a light sheet with a plurality of light emitting diodes (LEDs) interspersed with blank areas of the light sheet. The blank areas are preferably pierceable without damaging the power distribution grid of the light sheet. For embodiments of the bumper with the base part having the central body, one or more bumper members, and corresponding arm sections, the bumpers are preferably dimensioned such that, when one of the bumpers is installed on the light sheet, the central body and the one or more bumper members thereof each correspond positionally to a respective blank area of the blank areas of the light sheet.

In addition to aspects and embodiments described above, further aspects and embodiments will become apparent by reference to the appended drawings, wherein like reference numerals generally designate corresponding structures in the several views.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Example embodiments are described below with reference to the drawings, wherein:

FIG. 1 is a perspective view of an example backlight application, namely, a countertop;

FIG. 2 is a side view showing a light sheet configuration according to the prior art beneath such a countertop;

FIG. 3 is a perspective view of a portion of the light sheet configuration of FIG. 1 without the countertop;

FIG. 4 is a top perspective view of an example bumper according to the disclosure;

FIG. 5 shows the bumper of FIG. 4 without the cap;

FIG. 6 is a side view of the bumper of FIG. 4;

FIG. 7 is a sectional side view through the center plane of the bumper of FIG. 4;

FIG. 8 is a top view of a light sheet with a bumper according to FIG. 4;

FIG. 9 is a perspective view of another bumper according to the disclosure;

FIG. 10 is a side view of the bumper of FIG. 9;

FIG. 11 is a perspective view of another bumper according to the disclosure;

FIG. 12 is a side view of the bumper of FIG. 11;

FIG. 13 is a perspective view of another bumper according to the disclosure;

FIG. 14 is a perspective view of an optical modeling assembly including a light sheet with 8×8 LED grid, a bumper according to FIGS. 4-8, and a volume diffuser;

FIG. 15 is a top view of the optical modeling assembly of FIG. 14;

FIG. 16 shows irradiance maps of the exterior surface of the volume diffuser of FIGS. 14-15 without the bumper (left irradiance map) and with the bumper (right irradiance map);

FIG. 17 shows the radiant flux density along the X-axis and Y-axis for the irradiance maps of FIG. 16, where the left graph corresponds to the left irradiance map of FIG. 16 and the right graph corresponds to the right irradiance map of FIG. 16.

Before explaining example embodiments, it is to be understood that the invention is not limited in application to the details of particular arrangements shown in the drawings, since the invention is capable of other embodiments. Embodiments and figures disclosed herein are to be considered illustrative rather than limiting.

### DETAILED DESCRIPTION

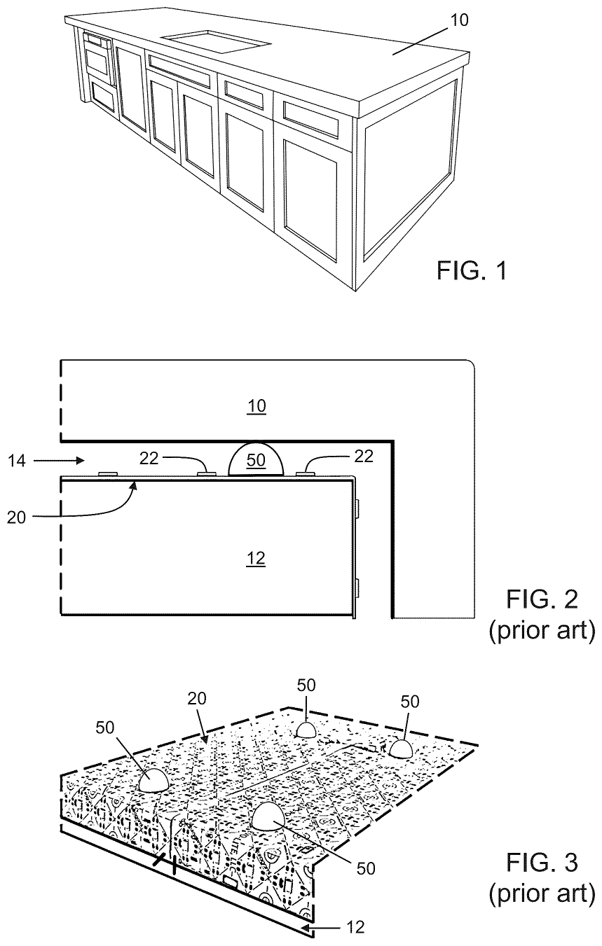

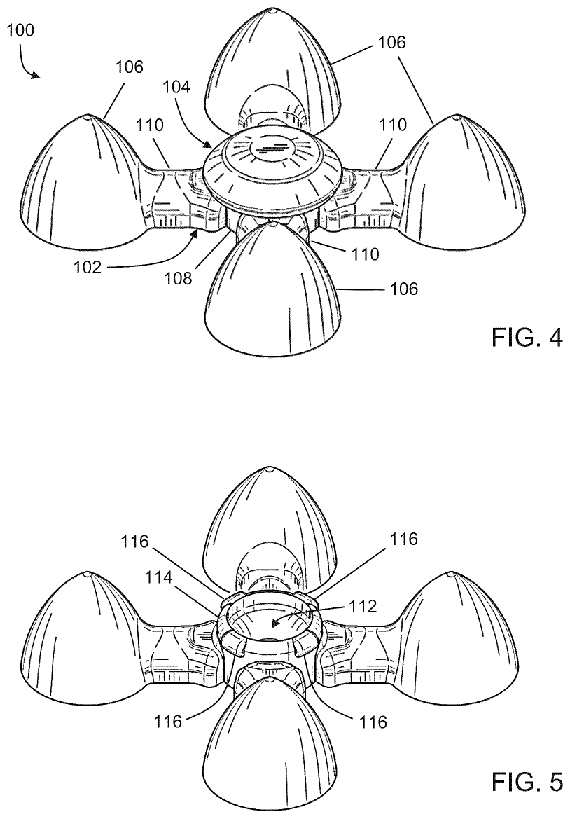

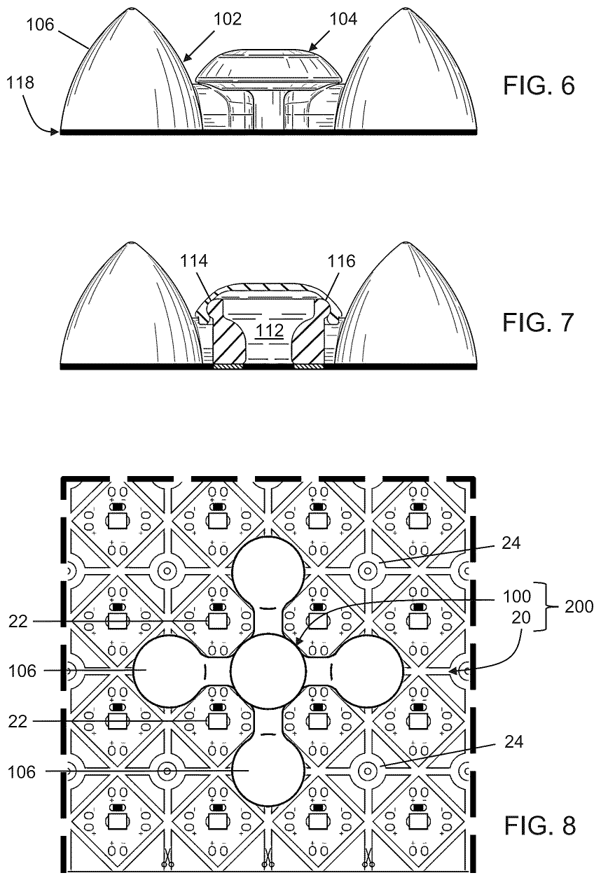

With reference to FIGS. 4-7, a bumper 100 comprises a base part 102 and a cap part 104. The base part 102 comprises one or more bumper members 106 and a central body 108. The depicted example has four bumper members 106. The bumper members 106 are the weight-bearing structures which maintain the gap 14 between the light sheet 20 and a backlit material, such as the countertop 10 for example (see FIGS. 1-3). It should be appreciated that the backlit material 10 may include opaque sections by design, in addition to translucent sections provided for light diffusion. Therefore, the bumper members 106 are preferably larger in height than the central body 108 with the cap part 104 thereon. However, it is also possible that these structures have the same or similar heights, such that the cap part 104 may also contact the backlit material 10. Each bumper member 106 is connected to the central body 108 by a respective arm or limb section 110. The arm sections 110 extend radially outward from the central body 108 to connect to a respective one of the bumper members 106 opposite the central body 108. Therefore, each arm section 110 is connected to the bumper member 106 at one end and to the central body at the other end. The arm sections 110 are preferably designed with reduced profiles to avoid obstructing the light dispersion from the light sheet 20. For example, the arm sections 110 may be smaller in height or width, or in both height and width, than the bumper members 106 and/or the central body 108. In this case, the arm section 110 extends between the lower portions of the central body 108 and bumper member 106.

The central body 108 has an opening 112 for receiving a fastener therethrough. Such fasteners can be used to mount the bumper 100 and light sheet 20 with respect to an underlying substrate, such as the counter substrate 12 for example (see FIGS. 1-3). The cap part 104 is attached to the top of the central body 108 to cover the opening 112 in a removable manner. In this way, when a fastener is installed in the opening 112, the cap part 104 is preferably used to prevent the fastener from being seen through the translucent backlit material. In the depicted example, the upper rim 114 of the opening 112, on the top side of the central body 108, has one or more outward projections or lugs 116 for elastically mounting the cap part 104 thereover. Of course, other embodiments may have different mounting configurations for the cap part 104.

Preferably, the bottom side of the base part 102 is provided with an adhesive backing 118. The adhesive backing 118 may be used to fix the bumper 100 on the light sheet 20, either additionally or alternatively to a fastener being installed through the opening 112 of the central body 108. The adhesive backing 118 is preferably designed in view of the materials to be adhesively joined, namely, the bumper surface material and light sheet surface material. To this end, the adhesive backing 118 may comprise multiple adhesive tapes or layers combined together. For example, if the bumper 100 is made of an injection-molded acrylonitrile butadiene styrene (ABS) plastic, an adhesive tape or layer that adheres well to ABS plastic should be selected for the side of adhesive backing 118 that interfaces with the bumper 100. Likewise, if the light sheet 20 has a silicone conformal coating, an adhesive tape or layer that adheres well to silicone should be selected for the other side of adhesive backing 118. Moreover, an intermediary adhesive tape or layer may be used to join such outer sides of the adhesive backing 118 and selected for this purpose. The adhesive backing 118 is preferably provided as a single adhesive pad corresponding or substantially corresponding in shape and size to the entire bottom side of the base part 102. This configuration maximizes the adhesive bonding surface while also only requiring the removal of a single adhesive backing sheet. Of course, other embodiments may have different configurations. For example, the adhesive backing 118 may be provided by more than one adhesive pads positioned on the bottom side of the base part 102, such as under the bumper members 108 and/or connecting arm sections 110.

In the depicted example of FIGS. 4-7, the bumper 100 has four bumper members 106 connected to the central body 108 with four respective connecting arms 110 arranged in a cross-shaped configuration, which provides excellent stability, and thus four points of contact with the backlit material 10. The arm sections 110 are preferably arranged around the central body 110 equidistant from one another to form the cross shape, in particular a perpendicular or 90° cross shape. However, since the bumper 100 can be mechanically fixed on the light sheet 20—in addition to being adhesively fixed—with a fastener inserted through the fastener opening 112 of the central body 108, alternative configurations may be used even if such configurations are relatively less stable against sheer forces and thus more susceptible to rolling over. For example, some embodiments may have three bumper members 106 with the arm sections 110 arranged around the central body 108 forming a T- or Y-shape depending on the design of the light sheet 20. Other embodiments may have two bumper members 106 with the arm sections 110 aligned in a transverse axis through the central body 108 forming an I-shape, or with the arm sections 110 arranged perpendicular to each other forming an L-shape. Indeed, the bumper 100 may only have a single bumper member 106 connected to the body 108. Various configurations are possible.

Referring now to FIG. 8, a light sheet installation kit 200 comprises a light sheet 20 and a plurality of bumpers 100. It is understood that only a small portion of the light sheet 20 is shown in FIG. 8, with additional bumpers 100 being installed at other portions of the light sheet 20. The light sheet 20 comprises a checkered pattern of LEDs 22 interspaced by blank areas 24. The blank areas 24 are indicated with concentric circles in this example, though other markings may be used for this purpose. The blank areas 24 are locations where fasteners (e.g., screws, nails, push pins, etc.) can be used to mount the light sheet 20 to an underlying substrate 12, without damaging the light sheet's power distribution grid. The blank areas 24 also provide available spaces for placing the bumper 100 as seen here. The bumper 100 is dimensioned such that, when the bumper 100 is installed on the light sheet, the central body 108 and the bumper members 106 thereof each correspond positionally to a respective blank area 24 of the light sheet 20.

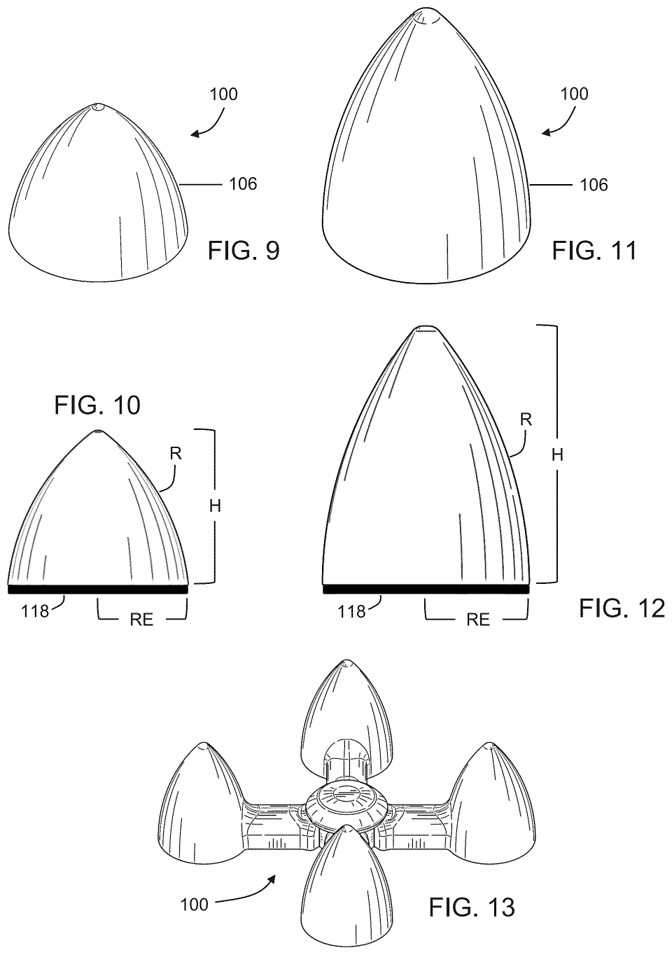

FIGS. 9-12 show additional embodiments primarily directed to light behavior optimization. Like the bumpers 50, the bumpers 100 of FIGS. 9-12 comprise a single bumper member 106 for maintaining the spacing between the light sheet 20 and backlight material 10. The bumpers 100 of FIGS. 9-12 also comprise an adhesive backing 118 as discussed above. Therefore, the above descriptions regarding the adhesive backing 118 apply equally to the bumpers 100 of FIGS. 9-12. The bumpers 100 of FIGS. 9-12 may be placed on respective blank areas 24 of the light sheet 20 as discussed above in reference to FIG. 8. Therefore, a light sheet installation kit 200 may also comprise a light sheet 20 and a plurality of bumpers 100 according to the embodiments of FIGS. 9-12.

The bumper member 106 in FIGS. 9-10 has the same profile as the bumper members 106 in FIGS. 4-8 except for the connection of the arm section 108. Likewise, FIG. 13 shows a bumper 100 similar to the bumper 100 of FIGS. 4-8, but with the profile of the bumper member 106 in FIGS. 11-12. Therefore, the above descriptions regarding the bumper of FIGS. 4-8 apply equally to the bumper 100 of FIG. 13. The following descriptions concerning the bumper profiles provided in reference to FIGS. 9-12 apply to the embodiments of FIGS. 4-8 and 13.

With reference to FIGS. 9-12 and the foregoing in mind, the bumper members 106 are preferably cone-shaped, as opposed to the semispherical or dome shape of the bumpers 50. In particular, each bumper member 106 preferably has a truncated cone shape with a convexly curved side surface that transitions into a convex or flat tip.

The bumper member 106 has a height H which extends from base to tip along the axis of the bumper member 106. This axis is the center vertical axis in the views of FIGS. 10-12. The bumper member 106 has a maximum radial extension RE transverse to the axis. The maximum radial extension RE is preferably at the base of the bumper member 106 as in the depicted examples. The maximum radial extension RE of the bumper member 106 is preferably 30-70% of the height H of the bumper member 106, and more preferably the maximum radial extension RE is 40-60% of the height H. In FIG. 10, the maximum radial extension RE is about 58% of the height H. For example, the maximum radial extension RE may be 7 mm and the height H may be 12 mm. In FIG. 12, the maximum radial extension RE is about 40% of the height H. For example, the maximum radial extension RE may be 8 mm and the height H may be 20 mm.

In extending from base to tip, the bumper member 106, in particular the outer lateral surface thereof, is convexly curved through at least a portion of its height H with a radius of curvature R. The ratio of the radius of curvature R to the height H of the bumper member 106 is preferably in the range of 1.3-1.7, and more preferably the ratio is 1.4-1.6. In FIG. 10, the ratio is about 1.43. In FIG. 12, the ratio is about 1.57. It should be appreciated that the ratio would be 1 (1:1) for a semicircular profile. It should be further appreciated that the radius of curvature R may be an approximation of the curvature through the portion, taking into account possible local variation.

The portion, through which the bumper member 106 is convexly curved with the radius of curvature R, preferably comprises at least 95% of the height H of the bumper member 106, and more preferably the portion comprises 97-99% of the height H of the bumper member 106. The tip portion of the bumper member 106 is rounded or flattened out to increase contact surface for the backlit material 10. In this way, the radius of curvature R transitions to a different curvature in the tip portion. Of course, the convexly curved extension of the bumper member 106 from base to tip along the height H may include multiple radii of curvature. Note that the tip portion of the taller bumper 100 of FIGS. 11-12 is more rounded, or less pointed, compared to the tip portion of the shorter bumper 100 of FIGS. 9-10, to make less susceptible to tipping or rolling over during installation as a result of its height.

Irrespective of embodiment, the material of the base part 102, which includes the one or more load-bearing bumper members 106, may be selected in view of the load and temperature requirements for a particular application. For example, the bumper 100 will typically have higher mechanical requirements for horizontal load-bearing applications, such as the countertop 10, in comparison to vertical applications, such as backlit wall displays. The load requirements for an individual bumper 100 also depends on the number of bumpers 100 used to support the backlit material 10, in addition to the weight of the backlit material 10 and the specified load capacity for the particular application. In general, the material of the base part 102 is preferably strong, hard, stiff, and tough with good compressive strength, impact resistance, and heat resistance. Each bumper member 106 may be rated to support up to 400 lbs. according to some embodiments.

For example, the base part 102 may be made of a strong heat-resistant plastic. According to some embodiments, the material is flame-retardant acrylonitrile butadiene styrene (ABS). Exemplary mechanical properties for such an ABS material are specified in the following table:

| PROPERTY | TEST | RESULT |
|---|---|---|
| Tensile Strength | ASTM D638 (50 | 420 kg/cm² |
| | mm/min, 3.2 mm) | (41.2 MPa) |
| Elongation at Break | ASTM D638 (50 | 27% |
| | mm/min, 3.2 mm) | |
| Flexural Strength | ASTM D790 (10 | 590 kg/cm² |
| | mm/min, 6.4 mm) | (57.9 MPa) |
| Flexural Modulus | ASTM D790 (10 | 21500 kg/cm² |
| | mm/min, 6.4 mm) | (2108 MPa) |
| IZOD Impact Strength | ASTM D256 (23° | 23 kg-cm/cm |
| | C., 6.4 mm) | (225 J/m) |
| Rockwell Hardness | ASTM D785 | 101 |
| | (R-Scale) | |

The cap part 104 is preferably made of an elastic material, such as a softer plastic or rubber for example, to allow the cap part 104 to be mounted over the one or more outward projections 116 in a push-on or snap-fit manner. The material of the cap part 104 is also selected to withstand temperature requirements in the gap 50 for the backlighting application.

Irrespective of embodiment, the bumper 100 is preferably white in color since the color white reflects visible light, and a white bumper is less likely to be seen through a translucent backlit material compared to other colored bumpers. In this respect, it should be noted that the light sheets 20 are also generally white. The bumper 100 may have a shiny or glossy surface finish with low absorption to augment its reflective properties. According to some embodiments, the material and surface finish of the bumper 100 is characterized by a bidirectional reflectance distribution function (BDRF) that is very white with a total integrated scatter (TIS)≥95% and specular component which includes glossy reflection, and which may also comprise mirror reflection.

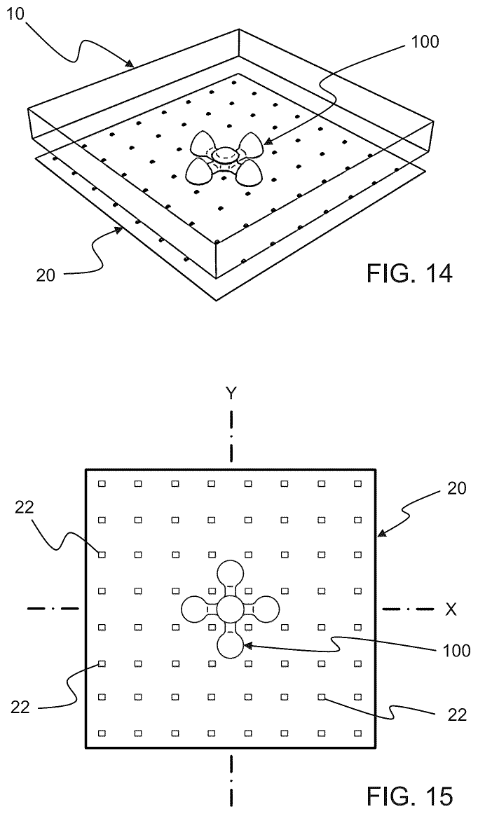

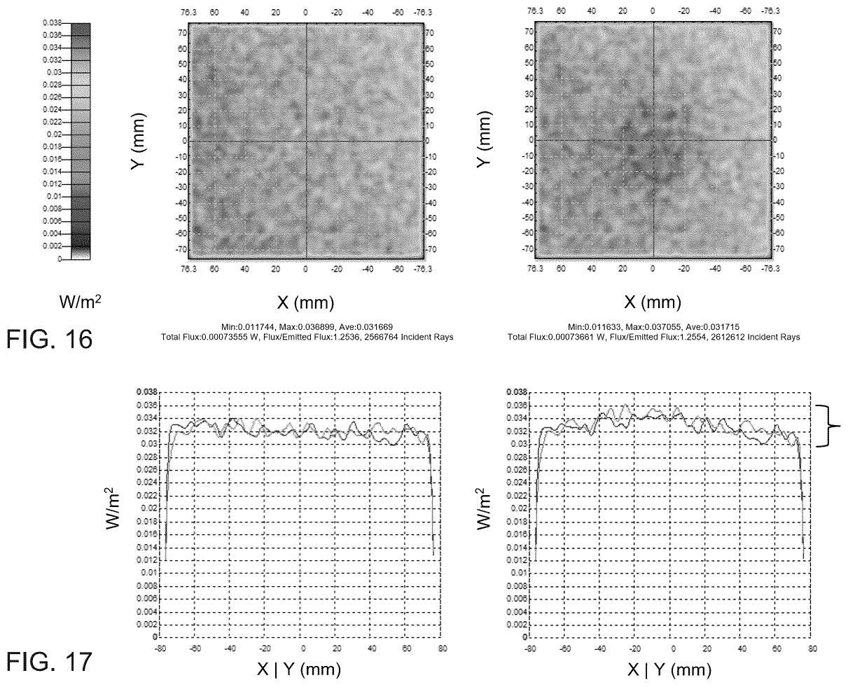

FIG. 14 shows a light sheet 20 with an 8×8 grid of single-color LEDs 22, a diffuser 10 (backlit material), and the bumper 100 according to FIGS. 4-8. The light sheet 20 is 95% diffuse white TIS. Each LED is 570 nm green with emitting flux of 92 μW which is arbitrary in terms of the linear relationship to results and scalability. The diffuser 10 is polycarbonate with a thickness of 19.05 mm (0.75 inch), 85% transmission at 2 mm, and 4° half power angle at 2 mm. The bumper 100 is positioned in the center of the light sheet LED grid at the intersection of the X-axis and Y-axis as seen in FIG. 15. FIG. 16 shows optically modeled irradiance maps of the exterior surface of the diffuser 10, which is opposite the bumper 100, without the bumper 100 (left map) and with the bumper 100 (right map) centered about the X-axis and Y-axis. In FIG. 17, the left graph shows the radiant flux density along the X-axis and Y-axis for the irradiance map without the bumper 100, and the right graph shows the radiant flux density along the X-axis and Y-axis for the irradiance map with the bumper 100. The boundary limitations of the model cause inaccurate data deviations along the periphery, which distorts the dataset, and therefore should be disregarded. As shown by FIGS. 16-17, the radiant flux density is relatively uniform in the model without the bumper 100 as expected. While the model with the bumper 100 exhibits greater variance in comparison, the variance is under 20% in the region between about 0.030-0.036 W/m² which is indicated by the bracket in FIG. 17. Such variance would not be perceived by the human eye, such that the exterior surface of the diffuser 10 would appear evenly illuminated to an observer. The bracketed region disregards the inaccurate outlier data produced at the model edges.

While several aspects and embodiments have been discussed herein, those persons skilled in the art will recognize numerous possible modifications, permutations, additions, combinations and sub-combinations therefor, without these needing to be specifically explained or shown within the context of this disclosure. The claims should therefore be interpreted to include all such modifications, permutations, additions and sub-combinations, which are within their true spirit and scope. Each embodiment described herein has numerous equivalents.

The terms and expressions which have been employed are used as terms of description and not of limitation, and there is no intention in the use of such terms and expressions of excluding any equivalents of the features shown or described, or portions thereof, but it is recognized that various modifications are possible within the scope of the invention. Thus, it should be understood that although the invention has been specifically disclosed by preferred embodiments and optional features, modification and variation of the concepts herein may be resorted to by those skilled in the art, and that such modifications and variations are considered to be within the scope of this invention as defined by the claims. Whenever a range is given in the specification, all intermediate ranges and subranges, as well as all individual values included in the ranges given are hereby incorporated into this disclosure. When a Markush group or other grouping is used herein, all individual members of the group and all combinations and sub-combinations possible of the group are hereby individually included in this disclosure. In general, the terms and phrases used herein have their art-recognized meaning, which can be found by reference to standard texts, references and contexts known to those skilled in the art. Any above definitions are provided to clarify their specific use in the context of the invention.

### LIST OF REFERENCE NUMERALS

10 translucent material
12 counter substrate
14 gap
20 light sheet
22 LEDS
24 fastener area
50 bumper
100 bumper
102 base
104 cap
106 bumper member
108 central body
110 connecting limb
112 fastener aperture
114 upper rim
116 projection
118 adhesive backing
200 light sheet installation kit
H axial height of bumper member
RE maximum radial extension
R radius of curvature

1. A bumper for maintaining a gap between a light sheet and a backlit material, comprising:
a base part having a central body, one or more bumper members, and at least one arm section which extends radially outward from the central body and which connects to a side of a respective bumper member of the one or more bumper members opposite the central body, wherein the central body has an opening for receiving a fastener therethrough, and
a cap part which is mountable to the base part for covering the opening of the central body.

2. The bumper of claim 1, wherein a bottom side of the base part is provided with adhesive backing for attaching the bumper to the light sheet.

3. The bumper of claim 1, wherein a rim of the opening, on a top side of the central body, has one or more outward projections for elastically mounting the cap part thereover.

4. The bumper of claim 1, wherein the bumper member is larger in height than the central body with the cap part thereon.

5. The bumper of claim 1, wherein the arm section is smaller in height and width than the central body and the bumper member, and the arm section extends between lower portions of the central body and the bumper member.

6. The bumper of claim 1, wherein the base part has two bumper members and two arm sections, and the two arm sections are arranged perpendicular to each other or aligned in a transverse axis through the central body.

7. The bumper of claim 1, wherein the base part has three bumper members and three arm sections.

8. The bumper of claim 1, wherein the base part has four bumper members and four arm sections, and the four arm sections are arranged around the central body equidistant from one another to form a cross shape.

9. The bumper of claim 1, wherein the bumper member has a height which extends from base to tip along an axis thereof, and a maximum radial extension of the bumper member transverse to the axis is 30-70% of the height of the bumper member.

10. The bumper of claim 9, wherein the maximum radial extension is 40-60% of the height of the bumper member.

11. The bumper of claim 1, wherein the bumper member has a height which extends from base to tip along an axis thereof, the bumper member is convexly curved through at least a portion of the height of the bumper member with a radius of curvature, and a ratio of the radius of curvature to the height of the bumper member is in the range of 1.3-1.7.

12. The bumper of claim 11, wherein the ratio of the radius of curvature to the height of the bumper member is 1.4-1.6.

13. The bumper of claim 11, wherein the portion comprises at least 95% of the height of the bumper member.

14. The light sheet installation kit of claim 11, wherein the portion comprises 97-99% of the height of the bumper member.

15. The bumper of claim 1, wherein the bumper member has a truncated cone shape with a convexly curved side surface that transitions into a convex or flat tip.

16. A light sheet installation kit for backlighting a backlit material, comprising:
a plurality of bumpers according to claim 1, and
a light sheet with a plurality of light emitting diodes (LEDs) interspersed with blank areas of the light sheet, wherein the blank areas are pierceable without damaging a power distribution grid of the light sheet,
wherein the bumpers are dimensioned such that, when one of the bumpers is installed on the light sheet, the central body and the one or more bumper members thereof each correspond positionally to a respective blank area of the blank areas of the light sheet.

17. A bumper for maintaining a gap between a light sheet and a backlit material, comprising:
a bumper member with a height, which extends from base to tip along an axis of the bumper member, and a maximum radial extension transverse to the axis that is 30-70% of the height of the bumper member,
wherein the bumper member is convexly curved through at least a portion of the height of the bumper member with a radius of curvature, and a ratio of the radius of curvature to the height of the bumper member is in the range of 1.3-1.7.

18. The bumper of claim 17, wherein a bottom side of the bumper member is provided with adhesive backing for attaching the bumper to the light sheet.

19. The bumper of claim 17, wherein the maximum radial extension is 40-60% of the height of the bumper member, and the ratio of the radius of curvature to the height of the bumper member is 1.4-1.6.

20. The bumper of claim 17, wherein the portion comprises at least 95% of the height of the bumper member.

21. The bumper of claim 17, wherein the portion comprises 97-99% of the height of the bumper member.

22. The bumper of claim 17, wherein the bumper member has a truncated cone shape with a convexly curved side surface that transitions into a convex or flat tip.

23. A light sheet installation kit for backlighting a backlit material, comprising:
a plurality of bumpers according to claim 17, and
a light sheet with a plurality of light emitting diodes (LEDs) interspersed with blank areas of the light sheet for attaching the bumpers.
